(19) United States
(12) Patent Application Publication
(10) Pub. No.: US 2008/0081643 A1
(43) Pub. Date: Apr. 3, 2008

(54) Mobile device system and mobile device

(76) Inventors: Hideki Nagata, Hachioji-shi (JP); Hiroyuki Minakata, Hachioji-shi (JP); Takayuki Ide, Fussa-shi (JP); Atsushi Kohashi, Akiruno-shi (JP); Minoru Omaki, Kunitachi-shi (JP)

Correspondence Address: KENYON & KENYON LLP, ONE BROADWAY, NEW YORK, NY, 10004, US

(21) Appl. No.: 11/903,480

(22) Filed: Sep. 21, 2007

(30) Foreign Application Priority Data
Sep. 28, 2006 (JP) 2006-264748

(51) Int. Cl. H04Q 7/20

(52) U.S. Cl. 455/456.6

(57) ABSTRACT

Even when the user carries a different combination of mobile devices on different days, the system can flexibly respond to those situations and misplacement of a mobile device can be prevented. Each mobile device includes a communication unit for communicating with other mobile devices, a GPS receiver for acquiring current location information of the mobile device, a group registration unit, a function-restricting unit for restricting a predetermined function, and a control unit. In each mobile device, other mobile devices located within a predetermined range of the mobile device are registered in the group registration unit as a group. After the registration, the other mobile devices located within the predetermined range of the mobile device are periodically detected, and the function-restricting unit is operated when the combination of the detected other mobile devices and the combination of the other mobile devices registered in the group registration unit differ.

### BACKGROUND OF THE INVENTION

1. Field of the Invention

The present invention relates to a mobile device system and a mobile device that are capable of quickly notifying misplacement of the mobile device.

This application is based on Japanese Patent Application No. 2006-264748, the content of which is incorporated herein by reference.

2. Description of Related Art

Recently, due to the diversification of information, when people go out, in many cases, they carry multiple mobile devices having various functions, such as mobile phones, laptop computers, information communication terminals, digital cameras, and music players (see Japanese Unexamined Patent Application, Publication No. 2002-9879).

Along with this trend, a technology for preventing users from forgetting to take their mobile device when going out or misplacing a mobile device outside the home has been proposed (see Japanese Unexamined Patent Application, Publication No. 2006-60544).

For example, Japanese Unexamined Patent Application, Publication No. 2006-60544 discloses a technology for periodically sending and receiving location information between a wireless key and a communication phone terminal, determining the distance therebetween on the basis of the information, and providing an alert when the determined distance becomes longer than a predetermined value when the user forgets to carry the mobile device.

### BRIEF SUMMARY OF THE INVENTION

A first aspect provides a mobile device system including a plurality of mobile devices, to each of which unique identification information is assigned, wherein each mobile device includes a communication unit for communicating with other mobile devices, a location-information acquisition unit for acquiring current location information, a group registration unit, a function-restricting unit for restricting a predetermined function, and a control unit, wherein the control unit in each mobile device links the location information acquired by the location-information acquisition unit of the mobile device and the identification information of the mobile device, sends the information to other mobile devices using the communication unit, detects the other mobile devices located within a predetermined range of the mobile device on the basis of the location information received from the other mobile devices by the communication unit and the location information of the mobile device, and registers the identification information of the detected other mobile devices in the group registration unit as a group, and wherein, after registration of the group, the control unit in each mobile device periodically detects the other mobile devices located within a predetermined range of the mobile device by periodically operating the communication unit and operates the function-restricting unit when the group status of the detected other mobile devices differs from the group status registered in the group registration unit.

A second aspect provides a mobile device system including a plurality of mobile devices to each of which unique identification information is assigned, wherein each mobile device includes a communication unit for communicating with other mobile devices positioned in the vicinity, a group registration unit, a function-restricting unit for restricting a predetermined function, and a control unit, wherein the control unit of the mobile device sends identification information assigned to the mobile device using the communication unit, detects the other mobile devices located in the vicinity of the mobile device on the basis of whether or not identification information from the other mobile devices has been received by the communication unit, and registers the identification information of the detected other mobile devices in the group registration unit as a group, and wherein, after registration of the group, the control unit in each mobile device periodically detects the other mobile devices located in the vicinity of the mobile device by periodically operating the communication unit and operates the function-restricting unit when the group status of the detected other mobile devices differs from the group status registered in the group registration unit.

A third aspect provides a mobile device including a communication unit for communicating with other mobile devices; a location-information acquisition unit for acquiring current location information of the mobile device; a group registration unit; a function-restricting unit for restricting a predetermined function; and a control unit, wherein the control unit links the location information acquired by the location-information acquisition unit of the mobile device and the identification information of the mobile device, sends the information to other mobile devices using the communication unit, detects the other mobile devices located within a predetermined range of the mobile device on the basis of the location information received from the other mobile devices by the communication unit and the location information of the mobile device, and registers the identification information of the detected other mobile devices in the group registration unit as a group, and wherein, after registration of the group, the other mobile devices located within a predetermined range of the mobile device are periodically detected by periodically operating the communication unit, and the function-restricting unit is operated when the group status of the detected other mobile devices differs from the group status registered in the group registration unit.

A fourth aspect provides a mobile device including a communication unit for communicating with other mobile devices located in the vicinity; a group registration unit; a function-restricting unit for restricting a predetermined function; and a control unit, wherein the control unit sends identification information assigned to the mobile device using the communication unit, detects the other mobile device located in the vicinity of the mobile device on the basis of whether or not identification information from the other mobile devices has been received by the communication unit, and registers the identification information of the detected other mobile devices in the group registration unit as a group, and wherein, after registration of the group, the other mobile devices located in the vicinity of the mobile device are periodically detected by periodically operating the communication unit, and the function-restricting unit is operated when the group status of the detected other mobile devices differs from the group status registered in the group registration unit.

### BRIEF DESCRIPTION OF THE SEVERAL VIEWS OF THE DRAWINGS

FIG. 1 illustrates the structure of a mobile device system according to a first embodiment.

FIG. 2 illustrates common components included in each mobile device of the mobile device system according to the first embodiment.

FIG. 3 illustrates example information stored in a storage unit of a mobile phone according to the first embodiment.

FIG. 4 is a flow chart illustrating the steps of a misplacement detection process executed in a control unit according to the first embodiment.

FIG. 5 illustrates an example display when a PDA and a personal computer are in the vicinity of a mobile phone.

FIG. 6 illustrates common components included in each mobile device of a mobile device system according to a second embodiment.

FIG. 7 illustrates example information stored in a storage unit of a mobile phone according to the second embodiment.

FIG. 8 is a flow chart illustrating the steps of a misplacement detection process executed in a control unit according to the second embodiment.

### DETAILED DESCRIPTION OF THE INVENTION

A mobile device system according to the present invention includes a plurality of mobile devices to each of which unique identification information is assigned, wherein each mobile device includes a communication unit for communicating with other mobile devices, a location-information acquisition unit for acquiring current location information, a group registration unit, a function-restricting unit for restricting a predetermined function, and a control unit, wherein the control unit in each mobile device links the location information acquired by the location-information acquisition unit of the mobile device and the identification information of the mobile device, sends the information to other mobile devices using the communication unit, detects the other mobile devices located within a predetermined range of the mobile device on the basis of the location information received from the other mobile devices by the communication unit and the location information of the mobile device, and registers the identification information of the detected other mobile devices in the group registration unit as a group, and wherein, after registration of the group, the control unit in each mobile device periodically detects the other mobile devices located within a predetermined range of the mobile device by periodically operating the communication unit and operates the function-restricting unit when the group status of the detected other mobile devices differs from the group status registered in the group registration unit.

According to this structure, location information acquired by the location-information acquisition unit of each mobile device is linked to identification information of each mobile device and is sent to other mobile devices by the communication unit. In this way, location information of each mobile device is mutually sent and received among the mobile devices. In each mobile device, other mobile devices within the predetermined range are detected on the basis of the location information from the other mobile devices, which is received by operating the communication unit, and location information of that mobile device. The identification information items of the detected other mobile devices are registered as a group in the group registration unit. In this way, even when the user carries a different combination of mobile devices on different days, the system can flexibly respond to those situations and can register the identification information of the mobile devices that are carried together as a group.

Then, after the above-described registration, by periodically sending and receiving location information and the like among the mobile devices, other mobile devices within a predetermined range of the mobile device is periodically detected in each mobile device. In this case, when the group status of the other mobile devices detected within a predetermined range of the mobile device and the group status registered in the group registration unit do not match because of misplacement by the user, the function-restricting units of each mobile device is operated to restrict a predetermined function. In this way, a predetermined function of the misplaced mobile device can be prevented from being used by someone else. Moreover, since a predetermined function of the mobile devices being carried becomes inoperable, the user can quickly notice the misplacement of a mobile device.

A mobile device system according to the present invention includes a plurality of mobile devices, to each of which unique identification information is assigned, wherein each mobile device includes a communication unit for communicating with other mobile devices located in the vicinity, a group registration unit, a function-restricting unit for restricting a predetermined function, and a control unit, wherein the control unit of the mobile device sends identification information assigned to the mobile device using the communication unit, detects the other mobile devices located in the vicinity of the mobile device on the basis of whether or not identification information from the other mobile devices has been received by the communication unit, and registers the identification information of the detected other mobile devices in the group registration unit as a group, and wherein, after registration of the group, the control unit in each mobile device periodically detects the other mobile devices located in the vicinity of the mobile device by periodically operating the communication unit and operates the function-restricting unit when the group status of the detected other mobile devices differs from the group status registered in the group registration unit.

According to this structure, the identification information uniquely assigned to each mobile device is sent to all of the other mobile devices within the communication range by operating the communication unit. In this way, identification information of each mobile device is sent and received among the mobile devices located in the vicinity. In each mobile device, other mobile devices in the vicinity of the mobile device are detected on the basis of whether or not identification information from the other mobile devices is received by the communication unit, and the detected other mobile devices are registered in the group registration unit as a group. In this way, even when the user carries a different combination of mobile devices on different days, the system can flexibly respond to those situations and can register the identification information of the mobile devices that are carried together as a group.

Then, after registration, by periodically sending and receiving identification information of each mobile device, other mobile devices located in the vicinity of the mobile device are periodically detected. In such a case, when the group status of the other mobile devices detected as being located in the vicinity of the mobile device and the group status registered in the group registration unit do not match because of misplacement or the like by the user, a predetermined function is restricted by operating the function-restriction unit in each mobile device. In this way, the predetermined function of the misplaced mobile device can be prevented from being used by someone else. Moreover, since a predetermined function of the mobile devices being carried becomes inoperable, the user can quickly notice the misplacement of a mobile device.

The communication unit may use wired or wireless communication. When using wireless communication, for example, a communication method such as Bluetooth, infrared communication, human-body communication, or NFC may be employed. When using wired communication, for example, a communication method using contact terminals may be employed.

In the above-described mobile device system, a communication range of the communication unit may be set to a range in which the mobile devices are presumed to be carried together by a user.

According to this structure, other mobile devices identified by identification information received by the communication unit can be presumed to be carried together with a mobile device by the user. The communication range is, for example, approximately 1 to 10 m.

In the above-described mobile device system, the communication unit is, for example, a short-range communication unit.

According to this structure, since a short-range communication unit is used as the communication unit, other mobile devices identified by the identification information received by the communication unit can be presumed to be carried together with a mobile device by the user. The short-range communication unit is, for example, Bluetooth.

In the above-described mobile device system, when the combination of the identification information of the detected other mobile devices and the combination of the identification information registered in the group registration unit as a group differ, or when the number of identification information items of the detected other mobile devices and the number of identification information items registered in the group registration unit as a group differ, the control unit of the mobile device may operate the function-restricting unit.

According to this structure, when the other mobile devices that were within the predetermined range are moved outside the predetermined range due to misplacement or the like, the combination or number of the other mobile devices detected as being located within the predetermined range of the mobile device or the combination or number of identification information items registered in the group registration unit as a group do not match. Therefore, by periodically monitoring the combination or number of items of the group, misplacement of a mobile device can be easily detected.

In the above-described mobile device system, the function-restricting unit may restrict a reception function.

According to this structure, since the reception function of the mobile device is restricted, for example, new mail transmitted to the misplaced mobile device can be prevented from being viewed by someone else.

In the above-described mobile device system, the function-restricting unit may restrict a transmission function.

According to this structure, since the transmission function of the mobile device is restricted, for example, transmission can be prevented from being carried out by someone else using the misplaced mobile device without permission.

In the above-described mobile device system, the function-restricting unit may restrict a display function.

According to this structure, since the display function of the mobile device is restricted, for example, data stored in the misplaced mobile device can be prevented from being viewed by someone else.

In the above-described mobile device system, the function-restricting unit may restrict a playback function.

According to this structure, since the playback function of the mobile device is restricted, for example, playback of audio and video data by someone else using the misplaced mobile device without permission can be prevented.

In the above-described mobile device system, the function-restricting unit may restrict a data-readout function.

According to this structure, since the data-readout function of the mobile device is restricted, for example, data stored in the misplaced mobile device can be prevented from being readout and used by someone else without permission.

A mobile device according to the present invention includes a communication unit for communicating with other mobile devices; a location-information acquisition unit for acquiring current location information of the mobile device; a group registration unit; a function-restricting unit for restricting a predetermined function; and a control unit, wherein the control unit links the location information acquired by the location-information acquisition unit of the mobile device and the identification information of the mobile device, sends the information of to other mobile devices using the communication unit, detects the other mobile devices located within a predetermined range of the mobile device on the basis of the location information received from the other mobile devices by the communication unit and the location information of the mobile device, and registers the identification information of the detected other mobile devices in the group registration unit as a group, and wherein, after registration of the group, the other mobile devices within a predetermined range of the mobile device are periodically detected by periodically operating the communication unit, and the function-restricting unit is operated when the group status of the detected other mobile devices differs from the group status registered in the group registration unit.

According to this structure, the location information acquired by the location-information acquisition unit is linked with the identification information of a certain mobile device and is sent to other mobile devices by the communication unit. In this way, a notification of location information of the mobile device can be sent to other mobile devices. When location information of the other mobile devices is received by the communication unit, the other mobile devices within the predetermined range of the mobile device are detected on the basis of the location information of the other mobile devices and the location information of the mobile device, and then the identification information of the detected other mobile devices is registered in the group registration unit as a group. In this way, even when the user carries a different combination of mobile devices on different days, the system can flexibly respond to those situations and can register the information of the mobile devices that are carried together as a group.

Then, after registration, by periodically receiving and transmitting location information between the mobile device and the other mobile devices, the other mobile devices within the predetermined range of the mobile device are periodically detected. In such a case, when the group status of other mobile devices detected within the predetermined range of the mobile device does not match the group status registered in the group registration unit due to misplacement or the like by the user, the function-restricting unit is operated. Therefore, if the mobile device is misplaced, predetermined functions can be prevented from being used by someone else, and if the mobile device is being carried, the user can quickly notice that a mobile device has been misplaced because a predetermined function becomes inoperative.

A mobile device according to the present invention includes a communication unit for communicating with other mobile devices located in the vicinity; a group registration unit; a function-restricting unit for restricting a predetermined function; and a control unit, wherein the control unit sends identification information assigned to the mobile device using the communication unit, detects the other mobile device located in the vicinity of the mobile device on the basis of whether or not identification information from the other mobile devices has been received by the communication unit, and registers the identification information of the detected other mobile devices in the group registration unit as a group, and wherein, after registration of the group, the other mobile devices located in the vicinity of the mobile device are periodically detected by periodically operating the communication unit, and the function-restricting unit is operated when the group status of the detected other mobile devices differs from the group status registered in the group registration unit.

According to this structure, the identification information uniquely assigned to a mobile device is sent to other mobile devices by operating the communication unit. In this way, the identification information of the mobile device can be notified to the other mobile devices located within the communication range of the communication unit. Furthermore, by operating the communication unit, other mobile devices located in the vicinity of the mobile device are detected on the basis of whether or not identification information of the other mobile devices is received, and the information of the detected other mobile devices is registered in the group registration unit. In this way, even when the user carries a different combination of mobile devices on different days, the system can flexibly respond to those situations and can register the information of the mobile devices that are carried together as a group.

Then, after registration, since the identification information of all mobile devices located within the communication range of the communication unit is periodically received, other mobile devices in the vicinity of the mobile device can be periodically detected. In this case, when the group status of other mobile devices detected as being located in the vicinity of the mobile device does not match the group status registered in the group registration unit due to misplacement or the like by the user, the function-restricting unit is operated. Therefore, if the mobile device is misplaced, predetermined functions can be prevented from being used by someone else, and if the mobile device is being carried, the user can quickly notice that a mobile device has been misplaced because a predetermined function becomes inoperative.

The various aspects described above can be employed in combination within the scope of the present invention.

The above-described mobile device system and mobile device is advantageous in that even when the user carries a different combination of mobile devices on different days, the system can flexibly respond to those situations and can prevent the mobile devices from being misplaced.

An embodiment of the mobile device system will be described below with reference to the drawings.

### FIRST EMBODIMENT

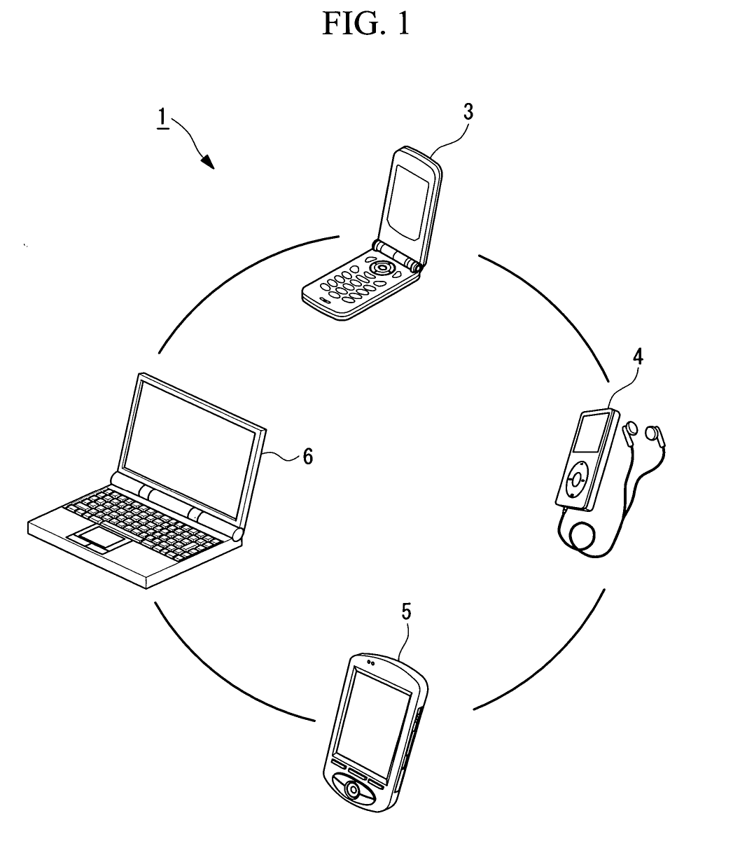

FIG. 1 illustrates the structure of a mobile device system 1 according to a first embodiment. As shown in the drawing, the mobile device system 1 includes a plurality of mobile devices or, more specifically, a mobile phone 3, a portable music player 4, a personal digital assistant (PDA) 5, and a laptop personal computer (hereinafter referred to as “computer”) 6. Unique identification information is assigned to each of these mobile devices.

These mobile devices are only examples, and any type of portable electronic device may be used in any combination. For instance, an example of a mobile device is a wearable personal computer that is embedded in clothes.

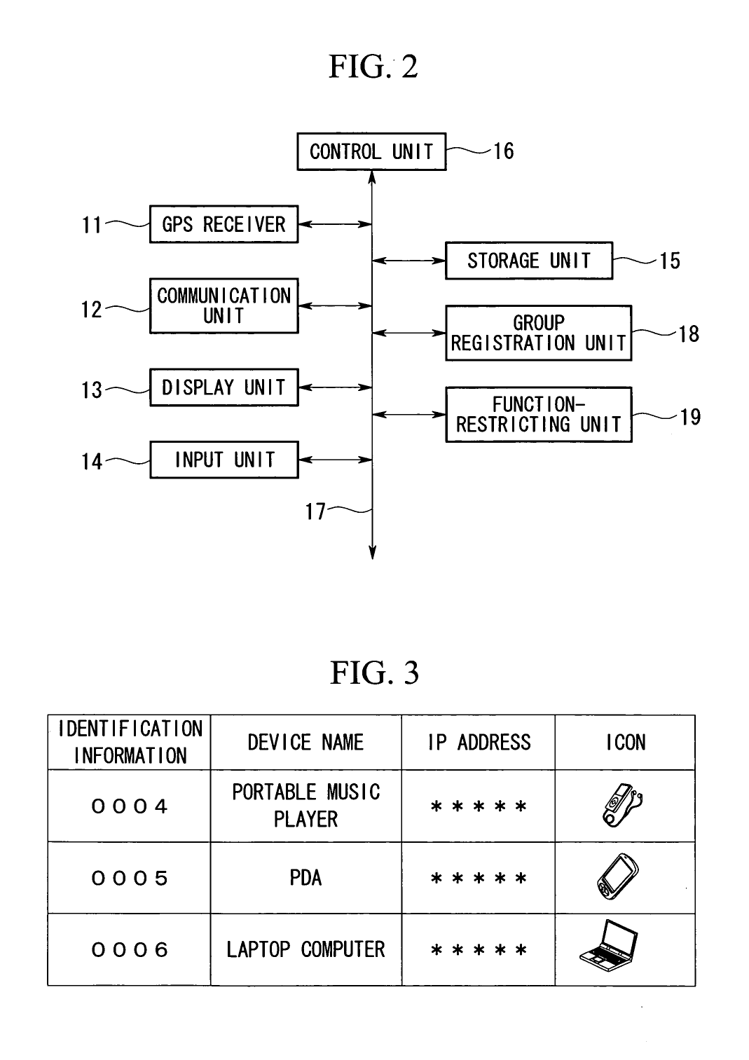

Each of the above-described mobile devices includes the following common components. More specifically, as illustrated in FIG. 2, each mobile device includes a GPS receiver (location-information acquisition unit) 11, a communication unit (communication device) 12, a display unit 13, an input unit 14, a storage unit 15, a control unit (control device) 16, a group registration unit (group registration device) 18, and a function-restricting unit (function-restricting device) 19. These units are mutually connected via a bus 17 and are capable of sending and receiving information between each other.

These components may be provided separately from components that are generally included in each mobile device, or the components that are generally included in each mobile device may also serve as the above-described components. For example, since the mobile phone 3 generally includes a communication unit, a display unit, and an input unit, any of these units, these components may preferably be shared. This also applies to the other mobile devices.

The GPS receiver 11 periodically receives a signal from a GPS satellite, acquires location information of its mobile device on the basis of the received signal, and outputs the location information to the control unit 16. The communication unit 12 is capable of communicating with other mobile devices by wireless communication. For example, the communication unit 12 of the mobile phone 3 is capable of communicating with the portable music player 4, the PDA 5, and the computer 6, respectively.

The display unit 13 is, for example, a liquid crystal display. The input unit 14 is, for example, keyboards or buttons and functions as a man-machine interface.

The storage unit 15 holds information about the other mobile devices. More specifically, the storage unit 15 holds identification information for each of the other mobile devices. Various kinds of information, including the device name, information for enabling two-way communication, and image data to be displayed on the display unit 13, are linked to the identification information of each mobile device. The information for enabling two-way communication is, for example, an IP address of the other party. The image data displayed on the display unit 13 is, for example, icons, character information, or the like. For example, as shown in FIG. 3, identification information of the portable music player 4, the PDA 5, and the computer 6 is stored in the storage unit 15 of the mobile phone 3. The device name, IP address, and image data to be displayed on the display unit 13 are linked to each identification information. The control unit 16 performs overall control of the above-described units.

Identification information of the other mobile devices within a predetermined range of the mobile device is registered in the group registration unit 18. When the combination of the other mobile devices within a predetermined range changes, the function-restricting unit 19 restricts a predetermined function of the mobile device. A predetermined function is, for example, a reception function, a transmission function, a display function, a playback function, or a data-readout function. The predetermined function may be selected by the user. Furthermore, the function to be restricted may differ depending on the mobile device.

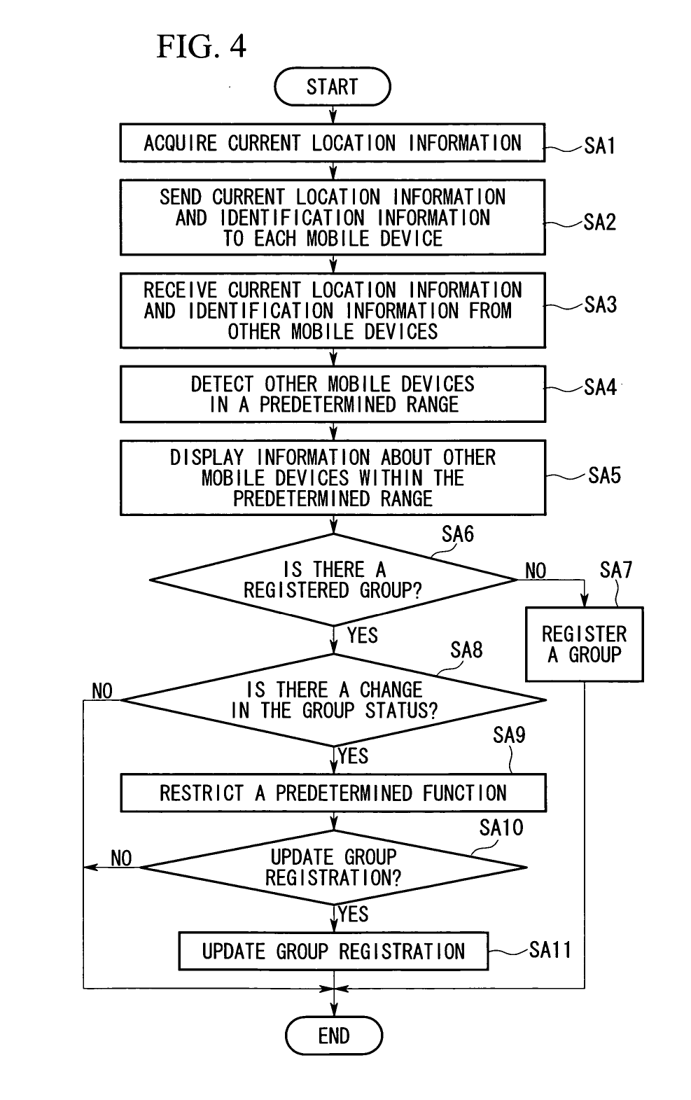

In the mobile devices having such common structures, the control units 16 repeatedly execute a misplacement detection process, as shown in FIG. 4, at predetermined intervals.

Although the process described below is executed in the control unit 16 of each mobile device, for simplification, the process executed by the control unit 16 of the mobile phone 3 will be described as a representative example.

First, when location information acquired by the GPS receiver 11 is input to the control unit 16 of the mobile phone 3 (Step SA1 of FIG. 4), information linking the location information to identification information “0003” of the mobile phone 3 is sent to other mobile devices via the communication unit 12 (Step SA2). In this way, the current location information and the identification information of the mobile phone 3 are sent to the portable music player 4, the PDA 5, and the computer 6. At the same time, the same process is executed in the control units 16 of the portable music player 4, the PDA 5, and the computer 6 so as to mutually send and receive the current location information of the mobile devices. In this way, the communication unit 12 of the mobile phone 3 receives the identification information and the current location information of the portable music player 4, the PDA 5, and the computer 6 (Step SA3).

Subsequently, on the basis of the received current location information of the portable music player 4, the PDA 5, and the computer 6 and the current location information of that mobile device, the control unit 16 determines whether or not the portable music player 4, the PDA 5, and the computer 6 are within a predetermined range of that mobile device and detects the other mobile devices within the predetermined range (Step SA4). Here, the predetermined range is a range for determining whether the other mobile devices are carried together with that mobile device and can be set arbitrarily according to the design. For example, the range can be set between approximately 3 and 5 m.

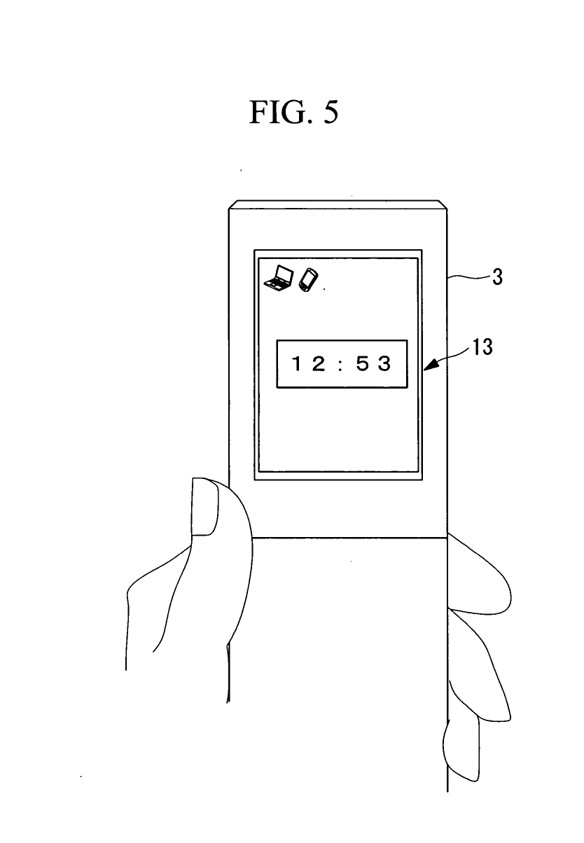

Then, the control unit 16 acquires icons linked to the identification information of the other mobile devices determined to be within the predetermined range from the storage unit 15 and displays the icons on the display unit 13 (Step SA5). In this way, icons for the other mobile devices within a predetermined range of the mobile phone 3 are displayed on the display unit 13. For example, FIG. 5 illustrates an example display on the display unit 13 when the PDA 5 and the computer 6 are determined to be within the predetermined range.

Subsequently, the control unit 16 determines whether or not a group has been registered in the group registration unit 18. According to this result, since a group has not yet been registered, the process proceeds to Step SA7, and the identification information of the other mobile devices determined to be within the predetermined range in Step SA4 is registered to the group registration unit 18. For example, if the PDA 5 and the computer 6 are determined to be within the predetermined range of the mobile phone 3 in Step SA4, the identification information “0005” of the PDA 5 and the identification information “0006” of the computer 6 are registered as a group in the group registration unit 18 of the mobile phone 3, and the process ends.

Next, after a predetermined amount of time, the control unit 16 executes the misplacement detection process shown in FIG. 4 again.

In this way, as described above, the other mobile devices within the predetermined range of the mobile phone 3 are detected, and information about these mobile devices is displayed on the display unit 13 (Steps SA1 to SA5). Then, in Step SA6, the control unit 16 determines whether or not a group has been registered in the group registration unit 18. According to this result, since a group is already registered, the process proceeds to Step SA8 so as to determine whether there is a change in the group status. More specifically, the control unit 16 determines whether or not the combination of mobile devices determined to be within the predetermined range of the mobile phone 3 through the above-described process matches the combination of mobile devices registered in the group registration unit 18. As a result, for example, if the PDA 5 and the computer 6 are determined to be within the predetermined range through this process or, in other words, if the registered other mobile devices are within the predetermined range of the mobile device also in this process, it is determined in Step SA8 that there is no change in the group status, and then the process ends.

When there is a change in the combination of mobile devices determined to be within the predetermined range of the mobile phone 3, that is, when the combination of mobile devices detected in Step SA4 differs from the combination of mobile devices registered as a group, the control unit 16 operates the function-restricting unit 19 to restrict a predetermined function (Step SA9). In this way, the mobile device the user is carrying becomes inoperable and the user can quickly notice misplacement of a mobile device. In this case, since the display unit 13 displays the mobile devices currently being carried, by looking at the display, the user can see which mobile device has been misplaced.

Since the function-restricting unit 19 is also operated in the misplaced mobile device, the misplaced mobile device can be prevented from being used by someone else.

Subsequently, the control unit 16 queries the user as to whether or not to update the group registration (Step SA10). This inquiry is carried out by, for example, displaying a message “Update group registration?” on the display unit 13 or providing an audio message. As a result, if there is an input for updating the group registration, the mobile devices detected in Step SA4 of the process are registered as a group in the group registration unit 18 (Step SA11), and then the process ends. If there is an input for not updating the group registration in Step SA10, the control unit 16 ends the process without updating the group registration.

Here, for example, when the user decides to increase the number of mobile devices he or she is carrying or when the user leaves a mobile device behind, then misplacement of a mobile device must be determined on the basis of the new combination of mobile devices. If the group registration was not updated, the same notification would be provided the next time the process is executed, and the user would be bothered by this notification. Thus, as described above, convenience can be enhanced by allowing the user to determine whether or not to update the group registration.

Then, the control unit 16 repeatedly executes the misplacement detection process, as shown in FIG. 4, at set intervals to periodically detect misplacement of a mobile device or the like and notifies the result to the user.

As described above, in this mobile device system 1, the other mobile devices that are determined to be within the predetermined range of a certain first mobile device are registered as a group. Thus, even when the user carries a different combination of mobile devices on different days, the system can flexibly respond to those situations and can register the mobile devices that are carried together as a group.

Since the function-restricting units 19 of the mobile devices are operated when the mobile devices registered as a group are not detected within the predetermined range of a certain mobile device, this fact can be quickly notified to the user and the misplaced mobile device can be prevented from being used by someone else.

According to this embodiment, whether there is a change in the group status is determined in Step SA8 in FIG. 4 on the basis of whether the combination of identification information registered in the group registration unit 18 matches the combination of identification information of the mobile devices detected in Step SA4. Instead, however, whether there is a change in the group status may be determined on the basis of whether the number of identification information items registered in the group registration unit 18 matches the number of identification information items of the mobile devices detected in Step SA4. In this way, the processing load can be reduced.

Group registration by the group registration unit 18 may be carried out, for example, when the user operates a registration request button provided on each mobile device for requesting registration.

A registration-cancellation area for canceling group registration in the group registration unit 18 may be registered in advance so that the group registration is cancelled when the mobile device is within the registration-cancellation area and the group registration is updated by automatically executing the misplacement process shown in FIG. 4 by the control unit 16 when the mobile device is outside the registration-cancellation area. In this case, for example, it is preferable to set the registration-cancellation area at the user's home. In this way, the misplacement process shown in FIG. 4 is automatically started when the user leaves his or her home, and the mobile devices carried out from the user's home are registered in the group registration unit 18 as a group. In this way, even when the combination of mobile devices carried out of the user's home changes day by day, the mobile devices can be registered as a group at an appropriate timing in accordance with the change of the combination. The registration-cancellation area can be determined by, for example, registering the location information of the registration-cancellation area in advance and determining whether the location information received by the GPS receiver 11 is included in the registration-cancellation area.

According to this embodiment, each mobile device may link and hold its own identification information and the identification information of the owner. In this case, the current location information of the mobile device is sent to the other mobile devices together with the owner identification information. In this way, not only the location information, but also the owner identification information is received and transmitted among the mobile devices. Each mobile device determines whether the owner identification information of that mobile device matches the owner identification information of the other mobile devices received by the communication unit 12. If these do not match, the operable functions are restricted by operating the function-restricting unit 19.

In this way, since the function-restricting unit 19 is operated when mobile devices having different owner identification information are carried, the user can quickly confirm that he or she is mistakenly carrying a mobile device owned by another person due to the restriction on the number of operable functions of the mobile device. In contrast, if the user's mobile device is mistakenly being carried by another person, the user's mobile device can be prevented from being used by that person.

A plurality of owner identification information items may be registered in one mobile device, and it is satisfactory if one of the registered owner identification information items matches. In this way, this embodiment can be employed when a plurality of users share one mobile device.

### SECOND EMBODIMENT

Next, a mobile device system according to a second embodiment will be described.

The mobile device system, similar to that according to the above-described first embodiment, includes, for example, a mobile phone 3, a portable music player 4, a PDA 5, and a computer 6. Hereinafter, for the mobile device system, descriptions of the parts that are the same as those according to the first embodiment are omitted, and only parts that differ will be described.

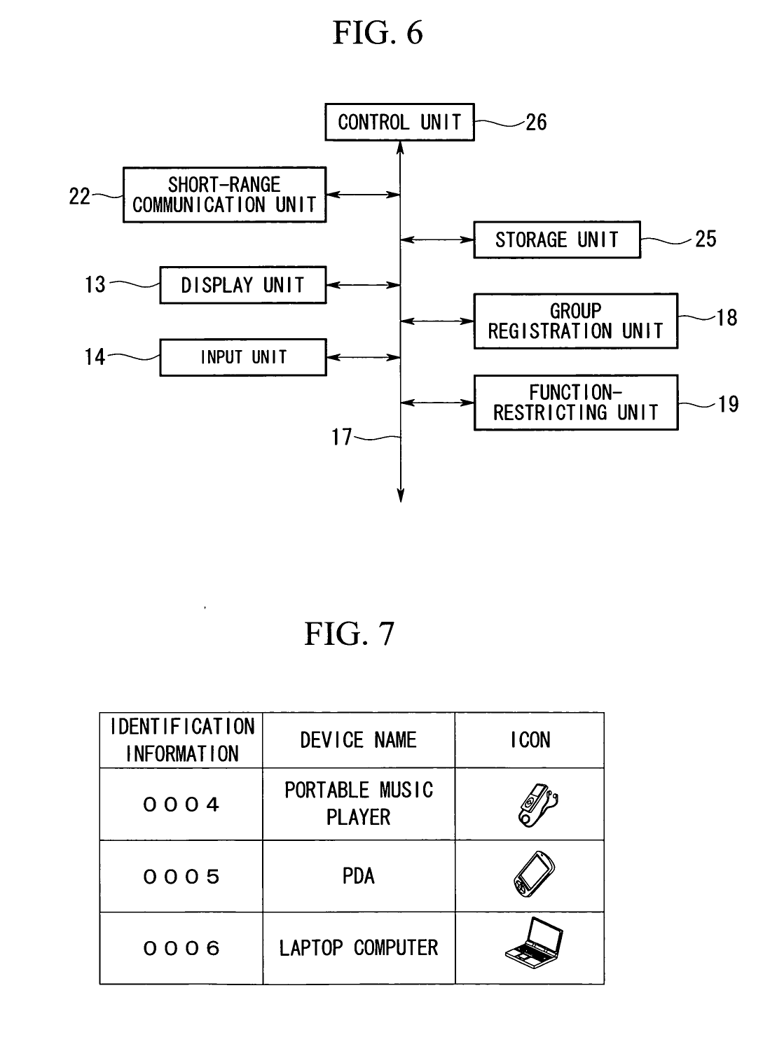

Each mobile device included in the mobile device system has the common elements shown in FIG. 6. More specifically, each mobile device includes a short-range communication unit (communication device) 22, a display unit (notification unit) 13, an input unit 14, a storage unit 25, a control unit (control device) 26, a group registration unit (group registration device) 18, and a function-restricting unit (function-restricting device) 19. These units are mutually connected via a bus 17 and are capable of sending and receiving information between each other.

The short-range communication unit 22 is capable of communicating with other mobile devices located in the vicinity.

It is preferable that the communication range of the short-range communication unit 22 be set to a range that allows communication between mobile devices being carried together, for example, a range of approximately 1 to 10 m. A known short-range communication device may be employed as the short-range communication unit 22. The short-range communication unit 22 may use wired or wireless communication. When using wireless communication, for example, a communication method such as Bluetooth, infrared communication, human-body communication, or NFC may be employed. When using wired communication, for example, a communication method using contact terminals may be employed.

The storage unit 25 holds information about the other mobile devices. More specifically, the storage unit 25 holds identification information for each of the other mobile device. Various kinds of information, including device names and image data to be displayed on the display unit 13, are linked to each identification information item. The image data displayed on the display unit 13 is, for example, icons, character information, or the like. For example, as shown in FIG. 7, each identification information of the portable music player 4, the PDA 5, and the computer 6 are stored in the storage unit 25 of the mobile phone 3, and device names and the image data to be displayed on the display unit 13 are linked to each item of identification information and are also stored. The control unit 26 performs overall control of the above-described units.

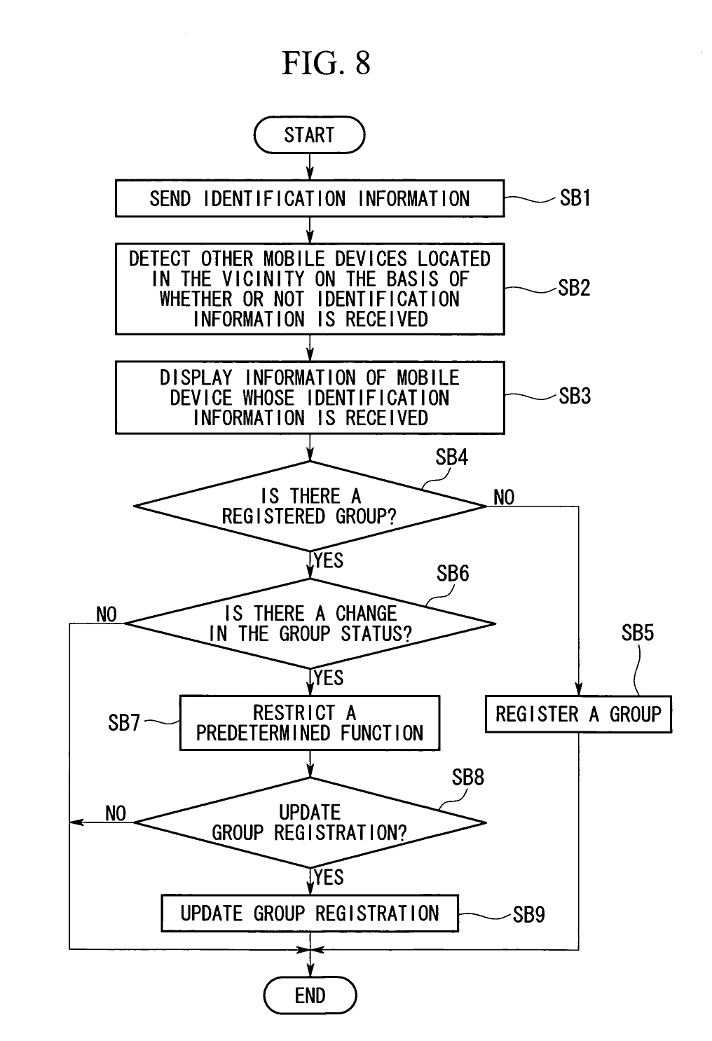

In the mobile devices having such common structures, the control units 26 repeatedly execute a misplacement detection process, as shown in FIG. 8, at predetermined intervals. Hereinafter, the misplacement detection process according to this embodiment will be described with reference to FIG. 8. Although the misplacement detection process described below is executed in the control unit 26 of each mobile device, for simplification, the process executed by the control unit 26 of the mobile phone 3 will be described as a representative example.

First, the control unit 26 of the mobile phone 3 sends identification information “0003” assigned to the mobile phone 3 by the short-range communication unit 22 (Step SB1). In this way, the identification information “0003” of the mobile phone 3 is received by the other mobile devices located within the communication range of the short-range communication unit 22 of the mobile phone 3. At the same time, the same process is executed in the control units 26 of the portable music player 4, the PDA 5, and the computer 6. In this way, identification information is sent and received between the mobile devices located within the communication range of the short-range communication unit 22.

Subsequently, the control unit 26 detects the other mobile devices located in the vicinity on the basis of whether or not the identification information of the other mobile devices has been received (Step SB2). Then, the control unit 26 acquires icons of the detected other mobile devices from the storage unit 25 and displays them on the display unit 13 (Step SB3). In this way, icons of the other mobile devices located in the vicinity of the mobile phone 3 are displayed on the display unit 13, and the user can thus confirm which mobile devices he or she is carrying together by viewing the display unit 13.

Subsequently, the control unit 26 determines whether or not a group is registered in the group registration unit 18 (Step SB4). According to the result, since a group is not yet registered, the process proceeds to Step SB5. The identification information of the other mobile devices detected to be located in the vicinity in the above-described Step SB2 is registered in the group registration unit 18, and the process ends. For example, if identification information of the PDA 5 and identification information of the computer 6 are received in Step SB2, the identification information “0005” of the PDA 5 and the identification information “0006” of the computer 6 are registered as a group in the group registration unit 18 of the mobile phone 3, and the process ends.

Next, after a predetermined amount of time, the control unit 26 executes the misplacement detection process shown in FIG. 8 again.

In this way, as described above, the other mobile devices located in the vicinity of the mobile phone 3 are detected, and this information is displayed on the display unit 13 (Steps SB1 to SB3). Then, in Step SB4, the control unit 26 determines whether or not a group is registered in the group registration unit 18. According to the result, since a group is already registered, the process proceeds to Step SB6 to determine whether there is a change in the group status. More specifically, the control unit 26 determines whether the combination of mobile devices detected as being located in the vicinity of the mobile phone 3 through the above-described process matches the combination of mobile devices registered in the group registration unit 18. As a result, for example, if the PDA 5 and the computer 6 are detected to be in the vicinity through the process, it is determined in Step SB6 that there is no change in the group status, and then the process ends.

On the other hand, when there is a change in the combination of mobile devices detected to be located in the vicinity of the mobile phone 3, that is, when the combination of mobile devices detected in Step SB2 differs from the combination of mobile devices registered as a group, the control unit 26 operates the function-restricting unit 19 to restrict a predetermined function (Step SB7). In this way, since the mobile device being carried becomes inoperable, the user can quickly notice misplacement of a mobile device. In such a case, since the mobile devices currently being carried are displayed on the display unit 13, by viewing the display, the user can determine which mobile device has been misplaced.

Since the function-restricting unit 19 is also operated in the misplaced mobile device, the misplaced mobile device can be prevented from being used by other person.

Subsequently, the control unit 26 queries the user as to whether or not to update the group registration (Step SB8). This is carried out by, for example, displaying a message “Update group registration?” on the display unit 13 or providing an audio message. As a result, if there is an input for updating the group registration, the mobile devices detected in Step SB2 of the process are registered as a group in the group registration unit 18 (Step SB9), and then the process ends. If there is no input for updating the group registration in Step SB8, the control unit 26 ends the process without updating the group registration.

Then, the control unit 26 repeatedly executes the misplacement detection process, as shown in FIG. 8, at set intervals to periodically detect misplacement or the like of a mobile device.

As described above, in this mobile device system, the other mobile devices located within the communication range of the short-range communication unit 22, i.e., in the vicinity, are registered as a group. Thus, even when the user carries a different combination of mobile devices on different days, the system can flexibly respond to those situations and can register the information of the mobile devices that are carried together as a group.

When the combination of the identification information of the other mobile devices detected as being located in the vicinity of the mobile device differs from the combination of the identification information of the other mobile devices registered as a group, this fact is notified to the user. Therefore, when misplacement occurs, the misplacement can be quickly detected and notified to the user.

According to this embodiment, whether there is a change in the group status is determined in Step SA6 in FIG. 8 on the basis of whether the combination of identification information registered in the group registration unit 18 matches the combination of identification information of the mobile devices detected in Step SB2. Instead, however, whether there is a change in the group status may be determined on the basis of whether the number of identification information items registered in the group registration unit 18 matches the number of identification information items of the mobile devices. Moreover, notification may be carried out when the identification information registered in the group registration unit 18 cannot be received. In this way, the processing load can be reduced.

Embodiments of the mobile device system and mobile devices have been described above in detail with reference to the drawings. However, specific structures are not restricted to the above-described embodiment, and modifications which do not depart from the spirit of the invention may be made.

What is claimed is:

1. A mobile device system comprising:
a plurality of mobile devices, to each of which unique identification information is assigned,
wherein each mobile device includes
a communication unit for communicating with other mobile devices,
a location-information acquisition unit for acquiring current location information,
a group registration unit,
a function-restricting unit for restricting a predetermined function, and
a control unit,
wherein the control unit in each mobile device
links the location information acquired by the location-information acquisition unit of the mobile device and the identification information of the mobile device, sends the information to other mobile devices using the communication unit, detects the other mobile devices located within a predetermined range of the mobile device on the basis of the location information received from the other mobile devices by the communication unit and the location information of the mobile device, and registers the identification information of the detected other mobile devices in the group registration unit as a group, and
after registration of the group, periodically detects the other mobile devices located within a predetermined range of the mobile device by periodically operating the communication unit and operates the function-restricting unit when the group status of the detected other mobile devices differs from the group status registered in the group registration unit.

2. A mobile device system comprising:
a plurality of mobile devices, to each of which unique identification information is assigned,
wherein each mobile device includes
a communication unit for communicating with other mobile devices located in the vicinity,
a group registration unit,
a function-restricting unit for restricting a predetermined function, and
a control unit,
wherein the control unit of each mobile device
sends identification information assigned to the mobile device using the communication unit, detects the other mobile devices located in the vicinity of the mobile device on the basis of whether or not identification information has been received from the other mobile devices by the communication unit, and registers the identification information of the detected other mobile devices in the group registration unit as a group, and
after registration of the group, periodically detects the other mobile devices located in the vicinity of the mobile device by periodically operating the communication unit and operates the function-restricting unit when the group status of the detected other mobile devices differs from the group status registered in the group registration unit.

3. The mobile device system according to claim 2 wherein the communication range of the communication unit is set to a range in which the mobile devices are presumed to be carried together by a user.

4. The mobile device system according to claim 2, wherein the communication unit is a short-range communication unit.

5. The mobile device system according to claim 1, wherein, when the combination of the identification information of the detected other mobile devices and the combination of the identification information registered in the group registration unit as a group differ, or when the number of identification information items of the detected other mobile devices and the number of identification information items registered in the group registration unit as a group differ, the control unit of each of the mobile devices operates the function-restricting unit.

6. The mobile device system according to claim 2, wherein, when the combination of the identification information of the other detected mobile devices and the combination of the identification information registered in the group registration unit as a group differ, or when the number of identification information items of the detected other mobile devices and the number of identification information items registered in the group registration unit as a group differ, the control unit of each of the mobile devices operates the function-restricting unit.

7. The mobile device system according to claim 1, wherein the function-restricting unit restricts the reception function.

8. The mobile device system according to claim 2, wherein the function-restricting unit restricts the reception function.

9. The mobile device system according to claim 1, wherein the function-restricting unit restricts the transmission function.

10. The mobile device system according to claim 2, wherein the function-restricting unit restricts the transmission function.

11. The mobile device system according to claim 1, wherein the function-restricting unit restricts a display function.

12. The mobile device system according to claim 2, wherein the function-restricting unit restricts a display function.

13. The mobile device system according to claim 1, wherein the function-restricting unit restricts a playback function.

14. The mobile device system according to claim 2, wherein the function-restricting unit restricts a playback function.

15. The mobile device system according to claim 1, wherein the function-restricting unit restricts a data-readout function.

16. The mobile device system according to claim 2, wherein the function-restricting unit restricts a data-readout function.

17. A mobile device comprising:
a communication unit for communicating with other mobile devices;
a location-information acquisition unit for acquiring current location information of the mobile device;
a group registration unit;
a function-restricting unit for restricting a predetermined function; and
a control unit,
wherein the control unit links the location information acquired by the location-information acquisition unit of the mobile device and the identification information of the mobile device, sends the information to other mobile devices using the communication unit, detects the other mobile devices located within a predetermined range of the mobile device on the basis of the location information received from the other mobile devices by the communication unit and the location information of the mobile device, and registers the identification information of the detected other mobile devices in the group registration unit as a group, and
wherein, after registration of the group, the other mobile devices located within a predetermined range of the mobile device are periodically detected by periodically operating the communication unit, and the function-restricting unit is operated when the group status of the detected other mobile devices differs from the group status registered in the group registration unit.

18. A mobile device comprising:
a communication unit for communicating with other mobile devices located in the vicinity;
a group registration unit;
a function-restricting unit for restricting a predetermined function; and
a control unit,
wherein the control unit sends identification information assigned to the mobile device using the communication unit, detects the other mobile device located in the vicinity of the mobile device on the basis of whether or not identification information has been received from the other mobile devices by the communication unit, and registers the identification information of the detected other mobile devices in the group registration unit as a group, and
wherein, after registration of the group, the other mobile devices located in the vicinity of the mobile device are periodically detected by periodically operating the communication unit, and the function-restricting unit is operated when the group status of the detected other mobile devices differs from the group status registered in the group registration unit.
